(19) United States
(12) Patent Application Publication
(10) Pub. No.: US 2007/0072958 A1
(43) Pub. Date: Mar. 29, 2007

(54) Aqueous Liquid For Ink-Jet Recording

(75) Inventors: Michiko Aoyama, Nagoya-shi, Aichi (JP); Yasuhiro Taga, Nagoya-shi, Aichi (JP)

Correspondence Address: BANNER & WITCOFF, LTD.;ATTORNEYS FOR CLIENT NOS. 0166889, 006760, 1001 G STREET, N.W., 11TH FLOOR, WASHINGTON, DC, 20001-4597, US

(73) Assignee: BROTHER KOGYO KABUSHIKI KAISHA, Nagoya-shi (JP)

(21) Appl. No.: 11/534,874

(22) Filed: Sep. 25, 2006

(30) Foreign Application Priority Data
Sep. 28, 2005 (JP) 2005-281494

(51) Int. Cl. C09D 11/00

(52) U.S. Cl. 523/160; 106/31.58; 106/31.86

(57) ABSTRACT

An aqueous liquid for ink-jet recording has a carboxyl group-containing compound that substantially prevents formation of insoluble compounds in the liquid from synthetic rubber materials used in components of the ink-jet head. The aqueous liquid may be a colorant-containing ink-jet recording ink or a colorant-free shipping preservative solution.

### CROSS REFERENCE TO RELATED APPLICATION

This application claims priority to Japanese Patent Application No. 2005-281494, filed Sep. 28, 2005, the entire disclosure of which is hereby incorporated by reference.

### BACKGROUND

Various techniques are known for ink-jet recording. In a static induction system, for example, ink is ejected by static induction force. Another technique provides a drop-on-demand system in which mechanical vibration or displacement is imparted to ink by a piezoelectric element. Another example is a thermal ink-jet system, in which ink is heated to generate bubbles and the resulting pressure used to eject ink droplets. In each of these methods, ink droplets are ejected through fine orifices provided in an ink-jet head and toward a recording material.

Accurate and stable ink flow through the fine orifices in the ink-jet head is important to achieve high-definition and rapid recording. The ink droplets usually have a particle size on the order of a few picoliters. Some efforts have been made to minimize the content of insoluble material present in the ink, which can lead to clogging of the fine orifices and other ink passages. Some techniques involve preparing ink in a clean room or precision-filtering ink through a sub-micron membrane filter. Another technique, as described in JP-A-10-52924, involves controlling the sodium ion concentration in the ink to fall within a range of from about 0.001 to about 0.2% by weight. Other efforts have been directed toward modifying materials used in the printer apparatus to limit the amount of insoluble material produced in the ink during recording. For example, JP-A-10-52924 describes preparing ink tanks from a resin and/or synthetic rubber which has a reduced amount of fatty acid and/or fatty acid derivative. The reduced amount of fatty acid and/or fatty acid derivative is said to prevent insoluble matter from being produced.

None of the above-described efforts has been effective to completely prevent ink-jet failure in ink-jet head nozzles.

### SUMMARY

The present invention is directed to an aqueous liquid for ink-jet recording. The aqueous liquid includes a carboxyl group-containing compound in an amount effect for substantially preventing formation of insoluble compounds from synthetic rubber material used in ink-jet recording devices.

### DETAILED DESCRIPTION

General Overview

The present inventors have found that a rubber member used in ordinary maintenance mechanisms for ink-jet heads contributes to formation of insoluble compounds in ink. The maintenance mechanism usually has a synthetic rubber cap to cover the nozzle of the ink-jet head and a synthetic rubber wiper to wipe the nozzle surface. When the synthetic rubber of the member contacts ink, metal compounds are released from the synthetic rubber and deposited on the nozzle surface. The metal compounds are then wiped from the nozzle surface by action of the wiper. As a result the nozzle can be clogged, causing ink-jet failure. Metal compounds may be present in various additives used in the synthetic rubber, such as vulcanization accelerators, vulcanization agents, lubricants, antioxidants, scorch retarders, and the like. One common example of such a metal compound is zinc dithiocarbamate, which is often used in vulcanization accelerators. Metal compounds also can be eluted into colorant-free shipping preservative solutions that are filled in the ink passage during shipping of ink-jet recording devices.

Aspects of the invention include an aqueous liquid for ink-jet recording. The aqueous liquid may be, for example, an ink-jet ink or a shipping preservative solution. The liquid may be used in ink-jet recording devices having a maintenance mechanism for the ink-jet head that is made with a synthetic rubber material. The aqueous liquid does not contribute to the formation of the insoluble compounds when contacted with the synthetic rubber material. By avoiding the formation of insoluble compounds, instances of ink-jet failure are avoided or substantially reduced.

In one aspect, an aqueous liquid for ink-jet recording comprises a carboxyl group-containing compound capable of preventing formation of insoluble compounds from a synthetic rubber member.

Illustrative Aspects of the Invention

Aqueous liquid for ink-jet recording, as used herein, refers to liquids commonly present in ink passages (e.g., ink tank, nozzle of ink-jet head, and the like) in ink-jet recording devices. The aqueous liquid of the invention comprises at least water and a carboxyl group-containing compound for preventing the formation of insoluble compounds from the synthetic rubber member of the ink-jet recording device. Non-limiting examples of aqueous liquids for ink-jet recording include colorant-containing inks for ink-jet recording and colorant-free shipping preservative solutions that are commonly filled in ink passages in ink-jet recording devices during shipping.

Though not wanting to be bound by theory, the carboxyl group-containing compound is believed to prevent metal compounds contained in synthetic rubber members from forming insoluble compounds by coordinating with the metal moiety of the released metal compound. This enables the metal compound to dissolve in the aqueous liquid.

The carboxyl group-containing compound has at least one carboxyl group in the molecule, and usually has two or more carboxyl groups. In general, compounds with more carboxyl groups have an increased ability to dissolve metal compounds in the aqueous liquid. The number of carbon atoms between neighboring carboxyl groups usually is 2 or 3, owing to the physical size of the ligand that coordinates with the metal moiety.

The amount of the carboxyl group-containing compound in the aqueous liquid may vary over a wide range. In general, if the amount is too low, it may be ineffective for preventing insoluble compounds from forming in the liquid. If the amount is too large, the viscosity of the aqueous liquid may increase, which can undesirably interfere with accurate and rapid ejection of the liquid. Usually, the amount the compound ranges from about 0.2 to about 5 wt %, often from about 0.2 to about 3 wt % or from about 0.5 to about 2 wt %.

Examples of compounds having one carboxyl group include, but are not limited to, sodium lactate, sodium benzoate, sodium acetate, and the like. Non-limiting examples of compounds having two or more carboxyl groups include disodium succinate, disodium malonate, sodium polylactate, sodium polyacrylate, sodium polyitaconate, and the like. Of these, sodium polyacrylate and sodium polyitaconate are particularly effective for increasing the affinity of ink for synthetic rubber. With respect to polymer-type compounds, if the molecular weight of the compound is too small, a greater amount of the compound is needed for preventing insoluble compounds from forming in the liquid. Excessive quantities of the compound may adversely influence ink ejection properties, as indicated above, and should be avoided. If the molecular weight of the polymer is too large, the viscosity of ink may increase. Given these considerations, the weight-average molecular weight (Mw) usually ranges from about 3,000 to about 10,000, often from about 4,000 to about 8,000.

Water used in the aqueous liquid for ink-jet recording usually is ion-exchanged water or high-purity distilled water. The amount of water used in the aqueous liquid usually ranges from about 10 to about 98 wt %, often from about 30 to about 95 wt %.

Examples of colorants that may be present in the aqueous liquid include dyes, such as direct dyes, acid dyes, or basic dyes, and pigments, such as dispersing agent-requiring pigments or self-dispersing pigments. The amount of the colorant generally ranges from a minimum amount needed to achieve the intended print density and a maximum amount above which ink may form precipitations when ink is dried, which can contribute to clogging of nozzles. The amount of the colorant usually ranges from about 0.2 to about 10 wt %, often from about 0.3 to about 5 wt %.

If desired, one or more various known additives such as humectant, penetrant, surfactant, viscosity modifier, surface tension modifier, pH modifier, anticorrosive agent, and mildew-proofing agent may be used in the aqueous liquid.

The aqueous liquid for ink-jet recording may be produced in an ordinary manner. For example, it may be produced by uniformly mixing a carboxyl group-containing compound with water and other additives.

Ink-jet recording devices in which the aqueous liquid may be used usually have a synthetic rubber material as a part of a maintenance mechanism for the ink-jet head. This synthetic rubber material contacts the aqueous liquid for ink-jet recording. Such synthetic rubber material may be present, for example, in a cap used to cover the nozzle of an ink-jet head, and/or a wiper to wipe the nozzle surface. The synthetic rubber material may also be used in ink tanks, O-rings, and the like in ink passages within the ink-jet recording device.

Examples of metal compounds that usually are contained in rubber materials include vulcanization accelerators such as zinc dithiocarbamate, zinc dimethyldithiocarbamate, zinc diethyldithiocarbamate, zinc dibutyldithiocarbamate, zinc ethylphenyldithiocarbamate, zinc dibenzyldithiocarbamate, iron dithiocarbamate, iron dimethyldithiocarbamate, copper dimethyldithiocarbamate, tellurium dithiocarbamate, tellurium diethyldithiocarbamate, sodium dimethyldithiocarbamate, sodium diethyldithiocarbamate, and the like; vulcanization agents such as magnesium methacrylate, zinc methacrylate, and the like; mold lubricants such as calcium stearate, magnesium oxide, and the like. In particular, zinc dithiocarbamate is frequently used.

### EXAMPLES 1 TO 4 AND COMPARATIVE EXAMPLES 1 TO 4

Examples 1-4 illustrate colorant-containing ink-jet recording ink as examples of aqueous liquids for ink-jet recording. The liquids of Examples 1-4 include a carboxyl group-containing compound. Comparative Examples 1-4 illustrate ink-jet recording inks that do not include a carboxyl group-containing compound. Examples 1-4 and Comparative Examples 1-4 are summarized in Table 1.

The ink-jet recording inks were prepared by mixing and stirring the compositions shown in Table 1, and then filtering the resulting mixture through a hydrophilic PTFE (polytetrafluoroethylene)-type membrane filter (products of Toyo Roshi Kaisha, Ltd.) having a pore size of 1.0 μm.

TABLE 1
(unit: wt %)

| | | Examples | | | | Comparative Examples | | | |
|---|---|---|---|---|---|---|---|---|---|
| Compositions | | 1 | 2 | 3 | 4 | 1 | 2 | 3 | 4 |
| Colorant | C.I. Direct Blue 199 | 0.5 | — | — | 0.5 | 0.3 | — | — | 0.3 |
| | C.I. Acid Red 52 | — | 0.3 | — | — | — | 0.5 | — | — |
| | CAB-O-JET ® 260 (*1) | — | — | 3.0 | — | — | — | 3.0 | — |
| Carboxyl | Sodium Lactate | 0.3 | — | — | — | | — | — | — |
| Group-containing | Disodium Succinate | — | 0.5 | — | — | — | — | — | — |
| Compound | Sodium Polyacrylate | — | — | 0.8 | — | — | — | — | — |
| | Mw = 5000 | | | | | | | | |
| | Sodium Polyitaconate | — | — | — | 1.0 | — | — | — | — |
| | Mw = 5000 | | | | | | | | |
| Carboxyl | Sodium | — | — | — | — | — | — | — | 0.5 |
| Group-Free | Polystyrenesulfonate | | | | | | | | |
| Compound | Mw = 5000 | | | | | | | | |
| Humectant | Glycerin | 25.0 | 25.0 | 25.0 | 25.0 | 25.0 | 25.0 | 25.0 | 25.0 |
| Penetrant | Triethylene Glycol | 3.0 | 3.0 | 3.0 | 3.0 | 3.0 | 3.0 | 3.0 | 3.0 |
| | N-butyl Ether | | | | | | | | |
| Water | Pure Water | Balance | balance | balance | balance | balance | balance | balance | balance |

*1: product of Cabot; having a colorant solid concentration of 10%.

These ink-jet recording inks were subjected to a contact test with synthetic rubber (isoprene-isobutyl rubber, products of Imai Rubber Co., Ltd.). After the test, the ink was filtered to determine the amount of the insoluble compounds therein. The contact test is as follows: 10 g of a synthetic rubber sheet having a thickness of 2.0 mm, a width of 12.5 mm and a length of 45.0 mm was put into 100 g of the ink. The sheet was subjected to an accelerated dipping test in a closed condition at 60° C. for 2 weeks. After the test, the ink was filtered through a hydrophilic PTFE-type membrane filter having a diameter of 47 mm and having a pore size of 1.0 μm, of which the dry weight (initial filter weight) had been previously measured. The solids remaining on the filter were washed away with pure water until the color of the colorant on the filter completely disappeared. Next, the filter with the solids adhering thereto was spontaneously dried, and the weight difference between the dried filter weight and the initial filter weight was obtained. The measured data were evaluated in the manner mentioned below, and the results are given in Table 2. The evaluation of the ink was given a rank as defined below. Ranks of “B” and “C” are unacceptable for performance considerations.
AA: The amount of the solids is less than 0.01 mg.
A: The amount of the solids is from 0.01 mg to less than 0.05 mg.
B: The amount of the solids is from 0.05 mg to less than 0.3 mg.

C: The amount of the solids is 0.3 mg or more.

TABLE 2

| | Evaluation of |
|---|---|
| | Insoluble Compounds |
| Example 1 | A |
| Example 2 | A |
| Example 3 | AA |
| Example 4 | AA |
| Comparative Example 1 | C |
| Comparative Example 2 | B |
| Comparative Example 3 | C |
| Comparative Example 4 | C |

As shown in Table 2, the amount of the insoluble compounds in the ink-jet recording inks of each of Examples 1 to 4 was less than that from the inks of Comparative Examples 1 to 4. Examples 3 and 4 illustrate that polymer-type carboxyl group-containing compounds are most effective for avoiding formation of insoluble compounds.

The invention is not limited to the embodiments described in the Examples, which are provided for illustrative purposes only. The material substances, their amounts used, and the conditions of producing them may be varied and modified without departing from the spirit and the scope of the invention as described herein.

What is claimed is:

1. An aqueous liquid for ink-jet recording comprising an effective amount of a carboxyl group-containing compound for substantially preventing formation of insoluble compounds from synthetic rubber material used in ink-jet recording devices.

2. The aqueous liquid of claim 1 which is a colorant-containing ink-jet recording ink.

3. The aqueous liquid of claim 1 which is a colorant-free shipping preservative solution.

4. The aqueous liquid of claim 1, wherein the amount of the carboxyl group-containing compound is from about 0.2 to about 5 wt %.

5. The aqueous liquid of claim 1, wherein the carboxyl group-containing compound has at least 2 carboxyl groups.

6. The aqueous liquid of claim 5, wherein neighboring carboxyl groups are separated by 2 or 3 carbon atoms.

7. The aqueous liquid of claim 1, wherein the carboxyl group-containing compound is sodium polyacrylate or sodium polyitaconate.

8. In combination, the aqueous liquid of claim 1 and an ink-jet recording device.

9. The combination of claim 8, wherein the synthetic rubber material is present in a rubber cap to cover an ink-jet head nozzle.

10. The combination of claim 8, wherein the synthetic rubber material is present in a wiper to wipe the nozzle surface.

11. The combination of claim 8, wherein the synthetic rubber material is present in an ink tank.

12. The combination of claim 8, wherein the synthetic rubber material is present in an O-ring.

13. The combination of claim 8, wherein the synthetic rubber material contains zinc dithiocarbamate.

14. An aqueous ink-jet recording ink comprising a compound selected from the group consisting of disodium succinate, disodium malonate, sodium polylactate, sodium polyacrylate, sodium polyitaconate, and combinations thereof, wherein the compound is present in an amount from about 0.2 to about 5 wt %.

15. The ink-jet recording ink of claim 14 wherein the compound is at least one of sodium polyacrylate and sodium polyitaconate.

16. A preservative solution for ink-jet recording devices comprising a compound selected from the group consisting of disodium succinate, disodium malonate, sodium polylactate, sodium polyacrylate, sodium polyitaconate, and combinations thereof, wherein the compound is present in an amount from about 0.2 to about 5 wt %.

17. The shipping preservation solution of claim 16 wherein the compound is at least one of sodium polyacrylate and sodium polyitaconate.
